(19) United States
(12) Patent Application Publication
(10) Pub. No.: US 2009/0142557 A1
(43) Pub. Date: Jun. 4, 2009

(54) Material for Providing Impact Protection

(76) Inventor: Montgomery G.B. Hardin, Berkshire (GB)

Correspondence Address: HARRY SHUBIN;MILLEN WHITE ZELANO AND BRANIGAN PC, 2200 CLARENDON BLVD STE 1400, ARLINGTON, VA, 22201, US

(21) Appl. No.: 10/580,558

(22) PCT Filed: Nov. 22, 2004
(86) PCT No.: PCT/IB04/04465

§ 371 Date: Sep. 28, 2007

Related U.S. Application Data
(60) Provisional application No. 60/524,883, filed on Nov. 26, 2003.

(51) Int. Cl. F41H 5/00; B32B 5/12; B29C 39/00

(52) U.S. Cl. 428/198; 428/317.9; 428/316.6; 428/327; 264/299

(57) ABSTRACT

A material and method for production of ballistic armor. One or more absorbing layers are inserted between layers of woven cloth made of high strength fibers. Mechanical energy absorbing layers are of two types, either a large number of small objects in loose contact with one another which will dissipate energy by moving traversely to the direction of impact, embedded in a matrix along with randomly oriented high strength fibers, or a large number of small objects in a matrix along with parallel oriented high strength fibers. A method for production of such a layered device is also taught. The material may be used in body armor including vests and helmets as well as applied to construction of shields and armored vehicles.

### FIELD OF INVENTION

The present invention is directed to a material and method for production that provides an improvement over current energy absorbing materials such as used in body armor. In particular, the invention relates to energy absorbing materials comprised of conventional front and back layers and a novel inner layer.

### BACKGROUND OF INVENTION

The concept of providing multiple layers of durable woven fibers for protective garments, helmets, shields and the like has been well established. This generally is in the category of soft ballistic armor. The softness is a requirement for discreteness, wearability and comfort of the user. The soft armor, typically made from “aramid” (polyparaphenylene terephthalamide) fibers (e.g., Dupont's Kevlar® brand), is often supplemented with metal or ceramic plates that are inserted into the pouches in a vest in front of the heart to provide additional protection from high velocity hand gun rounds.

Protective body armor is classified by the National Institute of Justice (NIJ) based on the level of protection it offers; Class I, Class II, and Class IIIA armor are soft body armor. Class III armor protects from high-velocity rifle rounds 7.62 mm, 150/M-80 ball round and all lesser threats. Class IV protects against the armor-piercing round 30.06, 165/A.P., at 2850 ft/sec., and all lesser threats.

U.S. Pat. No. 5,306,557 discloses that the main discovery in improving body armor has been the use of heavy-weave nylon-type cloth made of aramid fibers. So called soft ballistic armor, is made of multiple layers of woven fabric. The fabrics may be penetrated when yarn in the projectile's path is pushed aside or broken. The over-under weave of fabrics produces spots which are inherently weak where the fibers intersect. Improper interlacing or sewing of the layers of fiber can cause the strain wave to reflect, so that fibers break without dispersing a projectile's energy. Finally, the fibers in woven or sewn armor must overcome a state of crimp before they can be placed in tension.

Soft body armor has also been fabricated from polyethylene cloth. SPECTRA SHIELD, sold by Allied Signal Technologies, is a brand of such ballistic cloth. This material utilizes a unidirectional fiber in layers. The layers are cut, cross-plied (in a 0. degree, 90. degree orientation) and pressed to produce a single ply; the plies can be stacked to form a pliable material.

When fibers of soft, woven armor are struck by a projectile, most of the energy is spread over the armor so that much of the kinetic energy impacting the body is diminished in the deformation of the armor and the absorption of the fibers. The remaining energy is transmitted through the armor layer to the body, having the effect of a heavy blow. The more filaments a projectile engages, the more efficient the energy absorption, and the higher the degree of bullet deformation, although other factors such as the denier of the fabric, density and weave, also affect absorption.

The energy which is not absorbed by the fibers causes deformation, e.g., “backface deformation,” in which material is displaced by the projectile's impact and comes into direct contact with the wearer's body. Excessive deformation such as backface deformation results in significant blunt trauma, which can cause severe injury or death, even when the projectile does not penetrate the armor.

A typical armor construction is shown in U.S. Pat. Nos. 5,796,028 and 5,960,470. U.S. Pat. No. 5,960,470 describes a ballistic resistant panel constructed of a plurality of sheets of woven fibers. In addition, there is a puncture resistant panel that is also woven and comprised of multiple layers of aramid fibers. The edges of the layers are bound together with a securement tape.

Similarly, U.S. Pat. No. 5,796,028 describes a multiplicity of layers in their FIG. 1 comprised of a ballistic panel with inter-leaved layers. Each of the layers has interleaved plies of Spectra Shield™ high molecular weight polyethylene filaments in a flexible resin matrix and plies of aramid fiber cloth.

The most important factors to be considered in developing a new kind of body armor are: (1) its ability to prevent penetration of a projectile; and (2) its ability to reduce the amount of backface deformation (e.g., to less than 44 mm) and (3) heat retention of garments made from the armor. Other factors to be considered are the cost of the materials, the techniques of construction, the comfort of the wearer, weight, flexibility and inconspicuousness.

### SUMMARY OF THE INVENTION

The present invention is directed to a material and method for production that provides an improvement over current energy absorbing materials such as used in body armor. A distinctive feature of the present invention is the insertion of at least one special absorbing layer between layers of woven cloth made of high strength plastic fibers (such as aramid, nylon or polyethylene). One such special mechanical energy absorbing layers comprises a large number of small objects in loose contact with one another which will dissipate energy by moving transversely to the direction of impact. Interspersed between the small objects are randomly oriented high strength fibers. A second such special energy-absorbing layer comprises of a large number of small objects but with parallel strands of high strength fibers. A method for production of such a layered device is also taught. The material may be used in body armor including vests and helmets as well as applied to construction of shields, explosion-confining containers and armored vehicles. A major advantage of the present invention is less costly materials, less weight for a given level of protection and maintaining flexibility and wearability. Another advantage is that the inner layer does not become destroyed upon impact; it is not a sacrificial absorbent like the broken threads or shattered plates of competing compositions.

Thus, the present invention provides a useful material for absorption of shock from sudden impact as from a projectile or explosion, e.g., for fabrication of body armor, or bullet-proofing vehicles and spaces (such as on airline cabin doors). In particular, the invention comprises a multi-layered material having at least an inner layer and an outer layer of woven cloth of plastic fibers and a middle layer, the middle layer comprising pellets in a matrix of a loose array of randomly oriented fibers or a loose array of parallel oriented fibers, said layers being bound together transversely.

### BRIEF DESCRIPTION OF DRAWINGS

FIG. 1 is a front view of a typical body armor vest indicating the woven nature of the front and back pieces.

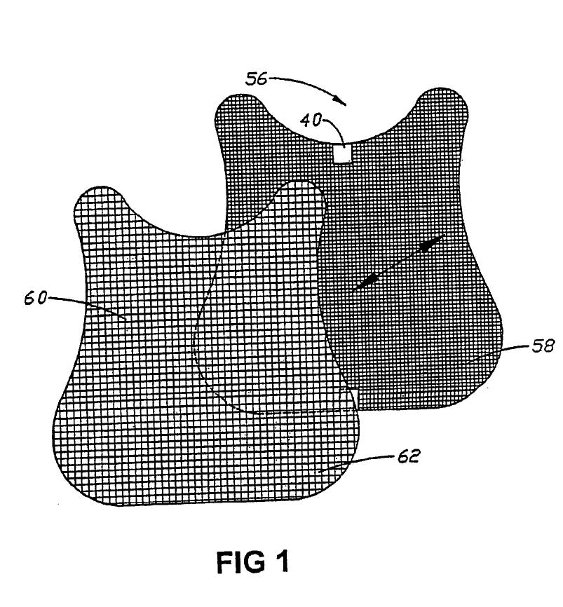

FIG. 2 is a more detailed front-fanned view showing the typical multiple layers of a vest required to provide adequate protection for handgun firearms.

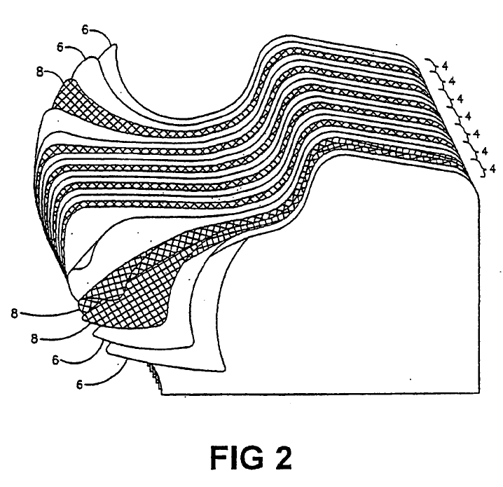

FIG. 3 is a cross-sectional view of a preferred embodiment of the material showing multiple layers where the top layer (#1) would be the front of the vest and would be equivalent to the woven aramid fibers shown in #60 of FIG. 1 and bottom layer (#7) would be equivalent to the woven aramid fibers shown in #58 of FIG. 1.

FIG. 4 is the front view of a preferred embodiment with top layers peeled back to illustrate orientation of fibers.

FIG. 5 is a cross-sectional view of a means of connecting the layers in this instance by stitching.

### DETAILED DESCRIPTION

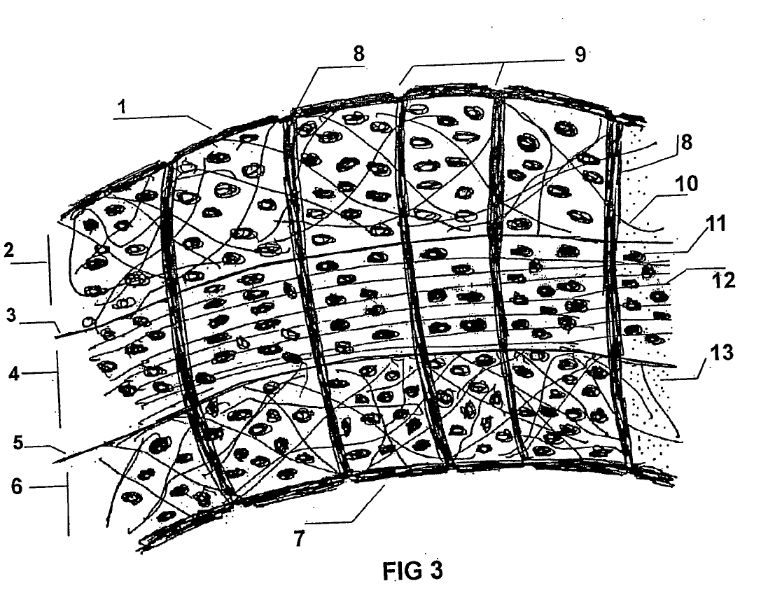

The present invention is a multi-layer material and method that can provide a higher degree of protection from sudden impact whether from a projectile or an explosion. It is preferably comprised of at least four distinct elements as illustrated in FIG. 3.

The first element is a woven material made from high strength fibers such as aramid (poly-paraphenylene terepbthalamide), nylon, polyethylene, silk or the like. This is used for the top layer (1) and bottom layer (7) and may also be used as optional separating sheets (3 and 5) between the special absorbing layers (2, 4 and 6). Preferably, the denier of woven layers 1,3,5,7 is equal to or less than 4000, more preferably in 20 to 400. Typical fibers usable in the woven material include Kevlar® produced by E.I. Dupont de Nemours & Company of Wilmington, Del., or other aramids such as Twaron® T-1000 and Twaron® T-2000 of AKZO NOBEL, Inc. Other materials are well known in the art, see e.g., U.S. Pat. No. 5,796,028.

On the top and bottom (1 and 7 respectively), this element serves as a containment layer. It also serves as anchor for the attachment of the randomly oriented fibers, e.g., high strength synthetic fibers such as those made of aramid, nylon or polyethylene. The outer coat itself could well be made of aramid fiber.

The second element is a layer of fibers (10) interspersed, preferably randomly, generally in an oblique orientation to the outer surface of the material. This layer also comprises small shock absorbing objects, e.g., beads (11). This element comprises, e.g., the layers 2 and optional layer 6. Matrix (13) surrounding the shock absorbing objects and randomly oriented high strength fibers may be formed of viscous material that solidifies into a flexible sheet upon curing.

Layer 2 and optional layer 6 are preferably the thickest layers and have high strength strands (such as aramid, nylon, silk, polyethylene) in oblique random irregular disposition. Such fibers can include those used for the woven layers above. Layers 2 and 6 have objects such as beads dispersed within the fibers of this layer. The shock absorbing objects should be tightly packed but not congested so as to allow movement within the layer but not excessive movement. Typically, a layer contains 20-40% pellets, 25-50% fibers and 10-35% viscous material, based on the total amount of these three components in the layer. In a preferred embodiment the ratios of these three components is: 40% pellets, 25% fibers and 25% viscous material, e.g., silicone solution. The beads themselves may be made of an elastomer, thermoplastic resins, ceramic or glass as discussed below. Random and/or oblique disposition of the high strength fiber allows the force striking at any angle to generate an angular force that will defect and dissipate the force at an angle to the direction of impact. This layer may be, e.g., several centimeters in thickness.

Layer 2 preferably exhibits a criss-cross arrangement of fibers, which will ensure that a force impacting at any angle will be converted to a large degree to a horizontal force perpendicular to the angle of impact, thus largely dissipating the force.

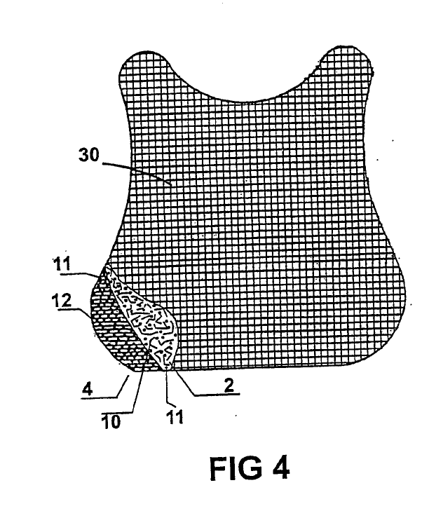

The optional third element is a matrix of parallel oriented high strength fibers (12) with shock absorbing objects, e.g., beads interspersed (11). This element is found in layer 4. The preferred orientation of the parallel fibers is indicated in FIG. 4 where the top layer has been peeled back to expose parallel fibers running transversely from left to right side of the vest. Interspersed shock-absorbing objects (11) are contained in both layers 2 and 4.

The fibers of layer 4 will be circumferentially arranged with some uniformity and the shock-absorbing objects will be dispersed uniformly within this layer. This layer will function like a trampoline allowing the missile or impact force to be reflected almost directly opposite to the direction of impact. The missile or force would have been significantly slowed down by the first layer.

Layer 4 will mainly serve as a cushion layer, like a trampoline table, allowing rebound along the axis of impact.

Layer 6 will dissipate any residual energy at right angles through the layer and surface of the material.

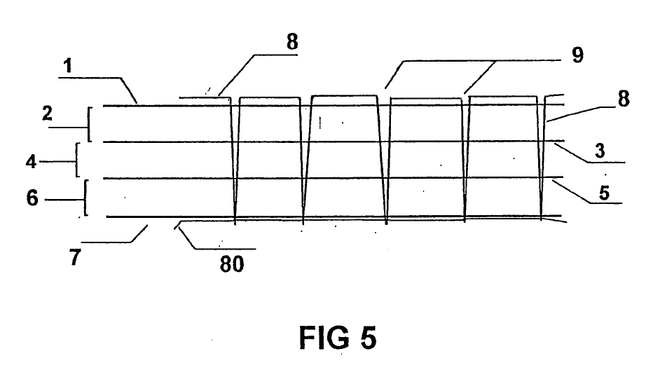

A fourth element is the optional linkage between the layers to tie them all together. This element is comprised of thick strands (8) of fibers running transversely between the layers. Such strands may be single or twisted multiple strands that are attached by one of several methods including stitching. Spacing may be approximately represented by the cross hatching indicated in FIG. 4 (30). The points of penetration 9 of the transverse fibers is indicated in FIGS. 4 and 5.

One manner of stitching is indicated in FIG. 5 where thick layers 2, 4 and 6 are seen in cross-section and sheet layers 1, 3, 5, and 7 are also indicated. The threads (8) are seen as running through the layers at points 9 where a second lower thread (80) is caught. Variations would include multiple loops on top or bottom. The method for making these through the layers connections 9 may be sewing machine type equipment; i.e., threaded needle thrust through the layers to catch an opposing thread on the opposite side. Alternatively, equipment used in production of non-wovens may be used in which case a needle pierces the layers and hooks a randomly oriented fiber from the opposing surface and pulls it through the layers.

An alternative method of forming cross-linkages include using thermal sealing of layers such as by using ultrasonics, a heat gun, radio frequency, microwaves, infrared or the like to “melt” the layers at various points so that they fuse together.

A further alternative method for forming cross-linkages is to use special adhesives to bond the layers together in such as ways as to form cells or tie points.

Regardless of the method for forming cross-linkages, the linking can serve to constrain movement of the layers, the embedding resin and the energy absorbing beads so that their displacement requires energy dissipation. The stitch or other cross-link may traverse all layers but is not pulled tight and does not compress or bring the layers together. Thus, the cross-linking need not increase the rigidity of the construct but may significantly reduce the force and tension of a projectile force or explosive force, leading to substantial loss of the force wave within that layer.

The method for forming the cross-layer linkages will also be dictated by the nature of matrix that suspends the fibers and beads of layers 2, 4 and 6. The chemical composition of the matrix (13) is formed of viscous material that solidifies into a flexible sheet upon curing. In the preferred embodiment this is a silicone. The curing may be by means of a chemical catalyst, by ultraviolet light, by thermal means or others available. Alternatives to the matrix may include polyester resin as used in fiber glass fabrication, epoxy resins, or other less rigid forms of material, e.g., a polymer having tacky surface contact with the pellets (see, e.g., U.S. Pat. No. 6,119,575).

A method for forming the sheet of layers 2 and 6 is to mix pellets and fibers into a solution of curable silicone rubber compound and poured into a form to create a thin layer upon curing.

The overall structure can have more or less than the layers specifically in preferred embodiments, described, e.g., with alternating criss-cross and transverse fibers. Preferably, the combination contains the criss-cross arrangement in some of the layers, which helps to convert the force hitting the layer directly to an angular force, and the uniform circumferential layers serves as a cushion to further slow down the force. Also preferably, the linkage between the layers traverses all the layers of the material and anchoring the outer to the inner layer, thereby ensuring that the whole structure and the individual compartments formed between the layers can withstand considerable pressure. Thus, the invention includes a material, as above, comprising a middle layer of pellets in a loose array of randomly oriented fibers; a material, as above, comprising a middle layer of pellets in a loose array of parallel oriented fibers; a material comprising a middle layer of pellets in a loose array of randomly oriented fibers and a layer of pellets in a loose array of parallel oriented fibers; and a material comprising a layer of pellets in a loose array of parallel oriented fibers, and on each side thereof a layer of pellets in a loose array of randomly oriented fibers.

The nature of the shock-absorbing objects in layers 2, 4 and 6 is typically small bits of polymer, and is typically 2-10, preferably 3-10, more preferably 3-8 mm in cross-section. The general shape of the preferred embodiment is spherical but may have an elliptical cross-section (such as from an oblate spheroid) or be irregular. For simplicity, all these types of small shock absorbing objects will be referred to as “pellets.” The preferred hardness is in the range of 30 to 80 durometer. The preferred chemical composition of the beads is elastomeric resins including polyurethane elastomers, fluoroelastomers and block copolymers. Other thermoplastic resins or elastomeric thermoplastics or natural elastomers (such as Kraton™ or rubber respectively) is also suitable. Alternatively, small bags containing silicone gel may be used, as well as ceramic or glass beads.

The range of thickness of the various layers can be varied considerably across a wide rang depending on the threat level to be faced or the situation in which the material would be used, e.g., as a helmet, bullet resistant vest, a container or automobile/aircraft armoring.

The design that is described will therefore considerably improve the ability of the material to withstand a bullet arriving at any angle or a contained explosion, thereby absorbing most of the force from the bullet or explosion and greatly minimizing the overall expression of the force and therefore the underlying injury. The greater the density of the high strength fiber (aramid, nylon, polyethylene, etc.) in each individual layer, the greater the ability of the layer to withstand the force of any bullet or explosion.

The materials of the invention can be assembled by conventional techniques, e.g., by web processes as sheets with subsequent layering of materials in a continuous application, curing, application, curing cycle.

The invention thus includes the following preferred embodiments:
1. A multi-layered material having at least an inner layer and an outer layer of woven cloth of plastic fibers and a middle layer, the middle layer comprising pellets in a matrix of a loose array of randomly oriented fibers or a loose array of parallel oriented fibers, said layers being bound together transversely.
2. A material according to embodiment 1, comprising a middle layer of pellets in a loose array of randomly oriented fibers.
3. A material according to embodiment 1, comprising a middle layer of pellets in a loose array of parallel oriented fibers.
4. A material according to embodiment 1, comprising a middle layer of pellets in a loose array of randomly oriented fibers, and a layer of pellets in a loose array of parallel oriented fibers.
5. A material as in embodiment 1, comprising a layer of pellets in a loose array of parallel oriented fibers, and on each side thereof a layer of pellets in a loose array of randomly oriented fibers.
6. A material as in embodiment 1 formed into shapes suitable for soft body armor.
7. A material as in embodiment 1, wherein said randomly oriented or parallel fibers are made of aramid, nylon or other synthetic compositions.
8. A material as in embodiment 1, wherein said randomly oriented or parallel fibers are made of natural fibers.
9. A material as in embodiment 1, wherein said pellets are of the size 2-10 mm in cross-section and formed of thermoplastic resins.
10. A material as in embodiment 1, wherein said matrix is formed of a flexible material that will form a solid continuum with fibers, pellets and matrix material in sheet form when heated.
11. A material according to embodiment 1, wherein the layers are cross-linked by stitching.
12. A material according to embodiment 1, wherein the layers are cross-linked by heating.
13. A material according to embodiment 1, wherein the layers are cross-linked with adhesives at periodic points of intersection of the layers.
14. A method for forming the matrix of embodiment 10, wherein pellets and fibers are mixed into a solution of curable silicone compound and poured into a form to create a thin layer upon curing.
15. The method of embodiment 14, wherein the pellets, fibers and solution are mixed at a ratio of 40% pellets, 25% fibers and 35% silicone solution.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth uncorrected in degrees Celsius and, all parts and percentages are by weight, unless otherwise indicated.

The entire disclosures of all applications, patents and publications, cited herein are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. A multi-layered material having at least an inner layer and an outer layer of woven cloth of plastic fibers and a middle layer, the middle layer comprising pellets in a matrix of a loose array of randomly oriented fibers or a loose array of parallel oriented fibers, said layers being bound together transversely.

2. A material according to claim 1, comprising a middle layer of pellets in a loose array of randomly oriented fibers.

3. A material according to claim 1, comprising a middle layer of pellets in a loose array of parallel oriented fibers.

4. A material according to claim 1, comprising a middle layer of pellets in a loose array of randomly oriented fibers, and a layer of pellets in a loose array of parallel oriented fibers.

5. A material as in claim 1, comprising a layer of pellets in a loose array of parallel oriented fibers, and on each side thereof a layer of pellets in a loose array of randomly oriented fibers.

6. A material as in claim 1 formed into shapes suitable for soft body armor.

7. A material as in claim 1, wherein said randomly oriented or parallel fibers are made of aramid, nylon or other synthetic compositions.

8. A material as in claim 1, wherein said randomly oriented or parallel fibers are made of natural fibers.

9. A material as in claim 1, wherein said pellets are of the size 2-10 mm in cross-section and formed of thermoplastic resins.

10. A material as in claim 1, wherein said matrix is formed of a flexible material that will form a solid continuum with fibers, pellets and matrix material in sheet form when heated.

11. A material according to claim 1, wherein the layers are cross-linked by stitching.

12. A material according to claim 1, wherein the layers are cross-linked by heating.

13. A material according to claim 1, wherein the layers are cross-linked with adhesives at periodic points of intersection of the layers.

14. A method for forming the matrix of claim 10, wherein pellets and fibers are mixed into a solution of curable silicone compound and poured into a form to create a thin layer upon curing.

15. The method of claim 14, wherein the pellets, fibers and solution are mixed at a ratio of 40% pellets, 25% fibers and 35% silicone solution.

16. A multi-layered soft body armour material having an inner layer (1) and an outer layer (5) of woven cloth of plastic fibers, a middle layer (2), comprising pellets in a matrix of a loose array of randomly oriented fibers, a middle layer (3) comprising pellets in a loose array of parallel oriented fibers, and a middle layer (4) comprising pellets in a matrix of a loose array of randomly oriented fibers, said layers being bound together transversely, said randomly oriented or parallel fibers being made of aramid or nylon, said pellets are of the size 2-10 mm in cross-section and formed of thermoplastic resins, said matrix is formed of a flexible material that will form a solid continuum with fibers, pellets and matrix material in sheet form when heated, and the layers are cross-linked by stitching.
